(19) United States
(12) Patent Application Publication
(10) Pub. No.: US 2014/0101405 A1
(43) Pub. Date: Apr. 10, 2014

(54) REDUCING COLD TLB MISSES IN A HETEROGENEOUS COMPUTING SYSTEM

(71) Applicant: ADVANCED MICRO DEVICES, INC., Sunnyvale, CA (US)

(72) Inventors: Misel-Myrto Papadopoulou, Toronto (CA); Lisa R. Hsu, Kirkland, WA (US); Andrew G. Kegel, Redmond, WA (US); Nuwan S. Jayasena, Sunnyvale, CA (US); Bradford M. Beckmann, Redmond, WA (US); Steven K. Reinhardt, Vancouver, WA (US)

(73) Assignee: ADVANCED MICRO DEVICES, INC., Sunnyvale, CA (US)

(21) Appl. No.: 13/645,685

(22) Filed: Oct. 5, 2012

(51) Int. Cl. G06F 12/10

(52) U.S. Cl. 711/207; 711/E12.061

(57) ABSTRACT

Methods and apparatuses are provided for avoiding cold translation lookaside buffer (TLB) misses in a computer system. A typical system is configured as a heterogeneous computing system having at least one central processing unit (CPU) and one or more graphic processing units (GPUs) that share a common memory address space. Each processing unit (CPU and GPU) has an independent TLB. When offloading a task from a particular CPU to a particular GPU, translation information is sent along with the task assignment. The translation information allows the GPU to load the address translation data into the TLB associated with the one or more GPUs prior to executing the task. Preloading the TLB of the GPUs reduces or avoids cold TLB misses that could otherwise occur without the benefits offered by the present disclosure.

### TECHNICAL FIELD

The disclosed embodiments relate to the field of heterogeneous computing systems employing different types of processing units (e.g., central processing units, graphics processing units, digital signal processor or various types of accelerators) having a common memory address space (both physical and virtual). More specifically, the disclosed embodiments relate to the field of reducing or avoiding cold translation lookaside buffer (TLB) misses in such computing systems when a task is offloaded from one processor type to the other.

### BACKGROUND

Heterogeneous computing systems typically employ different types of processing units. For example, a heterogeneous computing system may use both central processing units (CPUs) and graphic processing units (GPUs) that share a common memory address space (both physical memory address space and virtual memory address space). In general purpose computing using GPUs (GPGPU computing) a GPU is utilized to perform some work or task traditionally executed by a CPU. The CPU will hand-off or offload a task to a GPU, which in turn will execute the task and provide the CPU with a result, data or other information either directly or by storing the information where the CPU can retrieve it when needed.

While the CPUs and GPUs often share a common memory address space, it is common for these different types of processing units to have independent address translation mechanisms or hierarchies that may be optimized to the particular type of processing unit. That is, contemporary processing devices typically utilize a virtual addressing scheme to address memory space. Accordingly, a translation lookaside buffer (TLB) may be used to translate virtual addresses into physical addresses so that the processing unit can locate instructions to execute and/or data to process. In the event of a task hand-off, it may be likely that the translation information needed to complete the offloaded task will be missing from the TLB of the other processor type resulting in a cold (initial) TLB miss. To recover from a TLB miss, the task receiving processor must look through pages of memory (commonly referred to as a “page walk”) to acquire the translation information before the task processing can begin. Often, the processing delay or latency from a TLB miss can be measured in tens to hundreds of clock cycles.

### SUMMARY OF THE EMBODIMENTS

A method is provided for avoiding cold TLB misses in a heterogeneous computing system having at least one central processing unit (CPU) and one or more graphic processing units (GPUs). The at least one CPU and the one or more GPUs share a common memory address space and have independent translation lookaside buffers (TLBs). The method for offloading a task from a particular CPU to a particular GPU includes sending the task and translation information to the particular GPU. The GPU receives the task and processes the translation formation to load address translation data into the TLB associated with the one or more GPUs prior to executing the task.

A heterogeneous computer system includes at least one central processing unit (CPU) for executing a task or offloading the task with a first translation lookaside buffer (TLB) coupled to the at least one CPU. Also included are one or more graphic processing units (GPUs) capable of executing the task and a second TLB coupled to the one or more GPUs. A common memory address space is coupled to the first and second TLB and is shared by the at least one CPU and the one or more GPUs. When a task is offloaded from a particular CPU to a particular GPU, translation information is included in the task hand-off from which the particular GPU loads address translation data into the second TLB prior to executing the task.

### BRIEF DESCRIPTION OF THE DRAWINGS

The embodiments will hereinafter be described in conjunction with the following drawing figures, wherein like numerals denote like elements, and

FIG. 1 is a simplified exemplary block diagram of a heterogeneous computer system;

FIG. 2 is the block diagram of FIG. 1 illustrating a task off-load according to some embodiments;

FIG. 3 is a flow diagram illustrating a method for offloading a task according to some embodiments; and

FIG. 4 is a flow diagram illustrating a method for executing an offloaded task according to some embodiments.

### DETAILED DESCRIPTION

The following detailed description is merely exemplary in nature and is not intended to limit the disclosure or the application and uses of the disclosure. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, the following detailed description or for any particular computer system.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below as being “connected,” similar elements may be “coupled,” and vice versa. Thus, although the block diagrams shown herein depict example arrangements of elements, additional intervening elements, devices, features, or components may be present in an actual embodiment.

Finally, for the sake of brevity, conventional techniques and components related to computer systems and other functional aspects of a computer system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment.

Referring now to FIG. 1, a simplified exemplary block diagram is shown illustrating a heterogeneous computing system 100 employing both central processing units (CPUs) 102₀-102_{N} (generally 102) and graphic processing units (GPUs) 104₀-104_{M} (generally 104) that share a common memory (address space) 110. The memory 110 can be any type of suitable memory including dynamic random access memory (DRAM) such as SDRAM, the various types of static RAM (SRAM), and the various types of non-volatile memory (e.g., PROM, EPROM, flash, PCM or STT-MRAM).

While the CPUs 102 and GPUs 104 both utilize the same common memory (address space) 110, each of these different types of processing units have independent address translation mechanisms that in some embodiments may be optimized to the particular type of processing unit (i.e., the CPUs or the GPUs). That is, in fundamental embodiments, the CPUs 102 and the GPUs 104 utilize a virtual addressing scheme to address the common memory 110. Accordingly, a translation lookaside buffer (TLB) is used to translate virtual addresses into physical addresses so that the processing unit can locate instructions to execute and/or data to process. As illustrated in FIG. 1, the CPUs 102 utilize TLB_{cpu} 106, while the GPUs 104 utilize an independent TLB_{gpu} 108. As used herein, a TLB is a cache of recently used or predicted as soon-to-be-used translation mappings from a page table 112 of the common memory 110, which is used to improve virtual memory address translation speed. The page table 112 comprises a data structure used to store the mapping between virtual memory addresses and physical memory addresses. Virtual memory addresses are unique to the accessing process, while physical memory addresses are unique to the CPU 102 and GPU 104. The page table 112 is used to translate the virtual memory addresses seen by the executing process into physical memory addresses used by the CPU 102 and GPU 104 to process instructions and load/store data.

Thus, when the CPU 102 or GPU 104 attempts to access the common memory 110 (e.g., attempts to fetch data or an instruction located at a particular virtual memory address or attempts to store data to a particular virtual memory address), the virtual memory address must be translated to a corresponding physical memory address. Accordingly, the TLB is searched first when translating a virtual memory address into a physical memory address in an attempt to provide a rapid translation. Typically, a TLB has a fixed number of slots that contain address translation data (entries), which map virtual memory addresses to physical memory addresses. TLBs are usually content-addressable memory, in which the search key is the virtual memory address and the search result is a physical memory address. In some embodiments, the TLBs are a single memory cache. In some embodiments, the TLBs are networked or organized in a hierarchy as is known in the art. However the TLBs are realized, if the requested address is present in the TLB (i.e., “a TLB hit”), the search yields a match quickly and the physical memory address is returned. If the requested address is not in the TLB (i.e., “a TLB miss”), the translation proceeds by looking through the page table 112 in a process commonly referred to as a “page walk”. After the physical memory address is determined, the virtual memory address to physical memory address mapping is loaded in the respective TLB 106 or 108 (that is, depending upon which processor type (CPU or GPU) requested the address mapping).

In general purpose computing using GPUs (GPGPU computing) a GPU is typically utilized to perform some work or task traditionally executed by a CPU (or vice-versa). To do this, the CPU will hand-off or offload a task to a GPU, which in turn will execute the task and provide the CPU with a result, data or other information either directly or by storing the information in the common memory 110 where the CPU can retrieve it when needed. In the event of a task hand-off, it may be likely that the translation information needed to perform the offloaded task will be missing from the TLB of the other processor type resulting in a cold (initial) TLB miss. As noted above, to recover from a TLB miss, the task receiving processor is required to look through the page table 112 of memory 110 (commonly referred to as a “page walk”) to acquire the translation information before the task processing can begin.

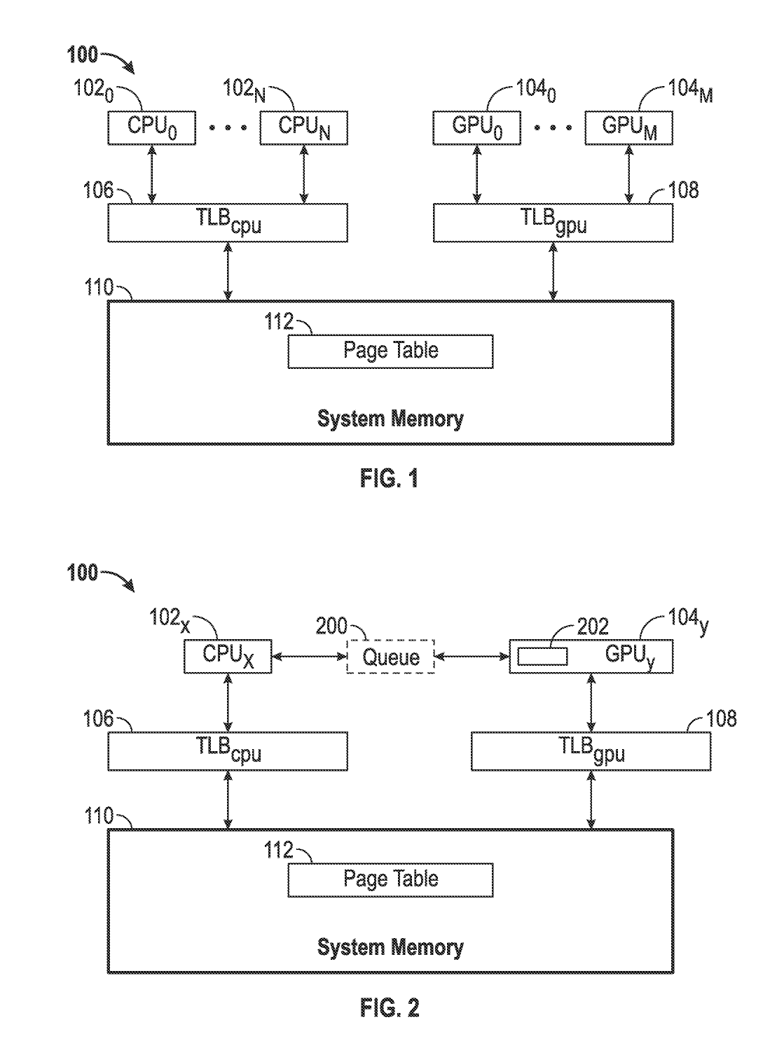

Referring now to FIG. 2, the computer system 100 of FIG. 1 is illustrated performing an exemplary task offload (or hand-off) according to some embodiments. For brevity and convenience, the task offload is discussed as being from the CPUₓ 102ₓ to the GPU_{y} 104_{y}, however, it will be appreciated that task off-loads from the GPU_{y} 104_{y} to the CPUₓ 102ₓ are also within the scope of the present disclosure. In some embodiments, the CPUₓ 102ₓ bundles or assembles a task to be offloaded to the GPU_{y} 104_{y} and places a description of (or pointer to) the task in a queue 200. In some embodiments, the task description (or its pointer) is sent directly to the GPU_{y} 104_{y} or via a storage location in the common memory 110. At some later time, the GPU_{y} 104_{y} will begin to execute the task by calling for a first virtual address translation from its associated TLB_{gpu} 108. However, it may be likely that the translation information is not present in TLB_{gpu} 108 since the task was offloaded and any pre-fetched or loaded translation information in TLB_{cpu} 106 is not available to the GPUs 104. This would result in a cold (initial) TLB miss from the first instruction (or call for address translation for the first instruction) necessitating a page walk before the offloaded task could begin to be executed. The additional latency involved in such a process detracts from the increased efficiency desired by originally making the task hand-off.

Accordingly, some embodiments contemplate enhancing or supplementing the task hand-off description (pointer) with translation information from which the dispatcher or scheduler 202 of the GPU_{y} 104_{y} can load (or pre-load) the TLB_{gpu} 108 with address translation data prior to beginning or during execution of the task. In some embodiments, the translation information is definite or directly related to the address translation data loaded into the TLB_{gpu} 108. Non-limiting examples of definite translation information would be address translation data (TLB entries) from TLB_{cpu} 106 that may be loaded directly into the TLB_{gpu} 108. Alternately, the TLB_{gpu} 108 could be advised where to probe into TLB_{cpu} 106 to locate the needed address translation data. In some embodiments, the translation information is used to predict or derive the address translation data for TLB_{gpu} 108. Non-limiting examples of predictive translation information includes compiler analysis, dynamic runtime analysis or hardware tracking that may be employed in any particular implementation. In some embodiments translation information is included in the task hand-off from which the GPU_{y} 104_{y} can derive the address translation data. Non-limiting examples of this type of translation information includes patterns or encoding for future address accesses that could be parsed to derive the address translation data. Generally, any translation information from which the GPU_{y} 104_{y} can directly or indirectly load the TLB_{gpu} 108 with address translation data to reduce or avoid the occurrences of cold TLB misses (and the subsequent page walks) is contemplated by the present disclosure.

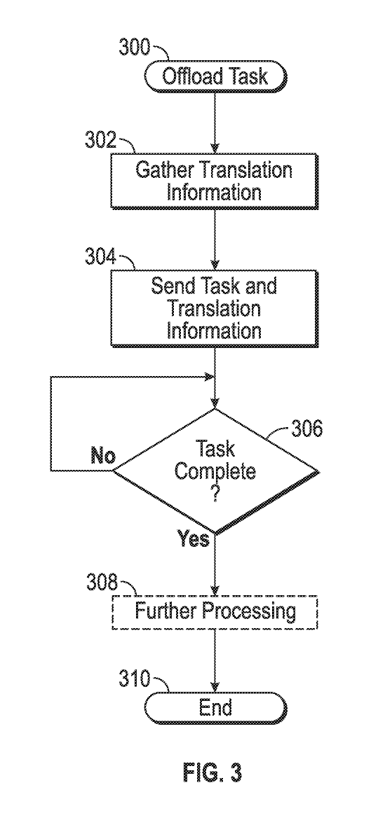

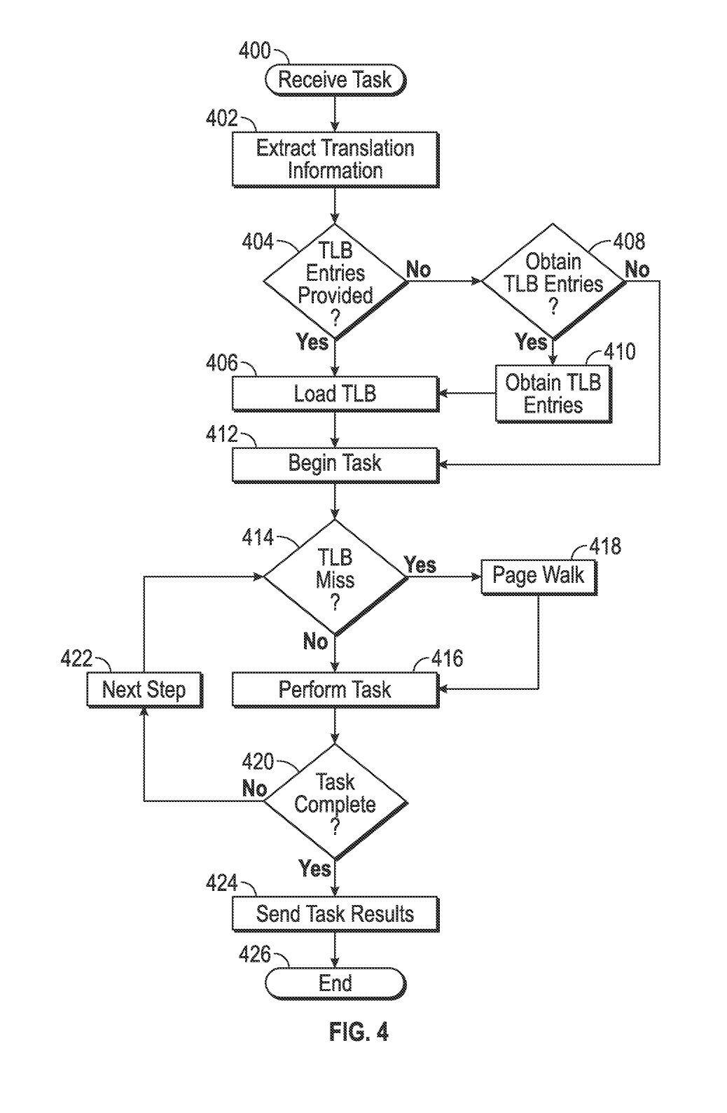

FIGS. 3-4 are flow diagrams useful for understanding the method of the present disclosure for avoiding cold TLB misses. As noted above, for brevity and convenience the task offload and execution methods are discussed as being from the CPUₓ 102ₓ to the GPU_{y} 104_{y}. However, it will be appreciated that task offloads from the GPU_{y} 104_{y} to the CPUₓ 102ₓ are also within the scope of the present disclosure. The various tasks performed in connection with the methods of FIGS. 3-4 may be performed by software, hardware, firmware, or any combination thereof For illustrative purposes, the following description of the methods of FIGS. 3-4 may refer to elements mentioned above in connection with FIGS. 1-2. In practice, portions of the methods of FIGS. 3-4 may be performed by different elements of the described system. It should also be appreciated that the methods of FIGS. 3-4 may include any number of additional or alternative tasks and that the methods of FIGS. 3-4 may be incorporated into a more comprehensive procedure or process having additional functionality not described in detail herein. Moreover, one or more of the tasks shown in FIGS. 3-4 could be omitted from embodiments of the methods of FIGS. 3-4 as long as the intended overall functionality remains intact.

Referring now to FIG. 3, a flow diagram is provided illustrating a method 300 for offloading a task according to some embodiments. The method 300 begins in step 302 where the translation information is gathered or collected to be included with the task to be off-loaded. As previously mentioned this translation information may be definite or directly related to address translation data to be loaded into the TLB_{gpu} 108 (e.g., address translation data from TLB_{cpu} 106) or the translation information may be used to predict or derive the address translation data for TLB_{gpu} 108. In step 304, the task and associated translation information is sent from one processor type to the other (e.g., from CPU to GPU or vice versa). In decision 306, the processor that handed-off the task (the CPU 102 in this example) determines whether the processor receiving the hand-off has completed the task. In some embodiments, the offloading processor periodically checks to see if the other processor has completed the task. In some embodiments, the processor receiving the hand-off sends an interrupt or other signal to the offloading processor which would cause an affirmative determination of decision 306. Until an affirmative determination is achieved, the routine loops around decision 306. Once the offloaded task is complete, further processing may be performed in step 308 if needed (for example, if the offloaded task was a sub-step or sub-process of a larger task). Additionally, the offloading processor may have offloaded several sub-tasks to other processors and needs to compile or combine the sub-task results to complete the overall process or task, after which, the routine ends (step 310).

Referring now to FIG. 4, a flow diagram is provided illustrating a method 400 for executing an offloaded task according to some embodiments. The method 400 begins in step 402 where the translation information accompanying the task hand-off is extracted and examined Next, decision 404 determines whether the translation information consists of address translation data that can be directly loaded into the TLB of the processor accepting the hand-off (for example, TLB_{gpu} 108 for a CPU-to-GPU hand-off). An affirmative determination means that TLB entries have been provided either from the offloading TLB (TLB_{cpu} 106 for example) or that the translation information advises the task receiving processor type where to probe the TLB of the other processor to locate the address translation data. This data is loaded into its TLB (TLB_{gpu} 108 in this example) in step 406.

A negative determination of decision 404 indicates that the translation information is not directly associated with the address translation data. Accordingly, decision 408 determines whether the offloading processor must obtain the address translation from the translation information (step 410). Such would be the case if the offloading processor needed to predict or derive the address translation data based upon (or from) the translation information. As noted above, address translation data could be predicted from compiler analysis, dynamic runtime analysis or hardware tracking that may be employed in any particular implementation. Also, the address translation data could be obtained in step 410 via parsing patterns or encoding for future address accesses to derive the address translation data. Regardless of the manner of obtaining that address translation data employed the TLB entries representing the address translation data are loaded in step 406. However, decision 408 could decide that the address translation data could not (or should not) be obtained (or attempted to obtain). Such would be the case if the translation information was discovered to be invalid or if the required translation is no longer in the physical memory space (for example, having been moved to a secondary storage media). In this case, decision 408 essentially ignores the translation information and the routine proceeds to begin the task (step 412).

To begin processing an offloaded task, the first translation is requested and decision 414 determines if there has been a TLB miss. If step 412 was entered via step 406, a TLB miss should be avoided and a TLB hit returned. However, if step 412 was entered via a negative determination of decision 408, it is possible that a TLB miss occurred, in which case a conventional page walk is performed in step 418. The routine continues to execute the task (step 416) and after each step determines whether the task has been completed in decision 420. If the task is not yet complete, the routine loops back to perform the next step (step 422), which may involve another address translation. That is, during the execution of the offloaded task, several address translations may be needed, and in some cases, a TLB miss will occur, necessitating a page walk (step 418). However, if execution of the task was entered via step 406, the page walks (and the associated latency) should be substantially reduced or eliminated for some task hand-offs. Increased efficiency and reduced power consumption are direct benefits afforded by the hand-off system and process of the present disclosure.

When decision 420 determines that the task has been completed, the task results are sent to the off-loading processor in step 424. This could be realized in one embodiment by responding to a query from the off-loading processor to determine if the task is complete. In another embodiment, the processor accepting the task hand-off could trigger an interrupt or send another signal to the off-loading processor indicating that the task is complete. Once the task results are returned, the routine ends in step 426.

A data structure representative of the computer system 100 and/or portions thereof included on a computer readable storage medium may be a database or other data structure which can be read by a program and used, directly or indirectly, to fabricate the hardware comprising the computer system 100. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the computer system 100. The netlist may then be placed and routed to produce a data set describing geometric shapes to be applied to masks. The masks may then be used in various semiconductor fabrication steps to produce a semiconductor circuit or circuits corresponding to the computer system 100. Alternatively, the database on the computer readable storage medium may be the netlist (with or without the synthesis library) or the data set, as desired, or Graphic Data System (GDS) II data.

The methods illustrated in FIGS. 3-4 may be governed by instructions that are stored in a non-transitory computer readable storage medium and that are executed by at least one processor of the computer system 100. Each of the operations shown in FIGS. 3-4 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

While exemplary embodiments have been presented in the foregoing detailed description, it should be appreciated that a vast number of variations exist. It should also be appreciated that the exemplary embodiments are only examples, and are not intended to limit the scope, applicability, or configuration in any way. Rather, the foregoing detailed description will provide those skilled in the art with a convenient road map for implementing the exemplary embodiments, it being understood that various changes may be made in the function and arrangement of elements described in the exemplary embodiments without departing from the scope as set forth in the appended claims and their legal equivalents.

What is claimed is:

1. A method for offloading a task from a first processor type to a second processor type, for the task to be performed by the second processor type, comprising:
receiving the task from the first processor, the first processor and the second processor utilizing a common memory address space;
receiving translation information for the task from the first processor type ;
using the translation information to load address translation data into a translation lookaside buffer (TLB) of the second processor type prior to executing the task.

2. The method of claim 1, wherein the first processor type is a central processing unit (CPU) and the second processor type is a graphics processing unit (GPU).

3. The method of claim 1, wherein the first processor type is GPU and the second processor type is a CPU.

4. The method of claim 1, wherein the translation information includes page table entries and the method further comprises loading the page table entries into the TLB of the second processor type prior to executing the task.

5. The method of claim 1, further comprising:
obtaining the address translation data based upon the translation information; and
loading the address translation data into the TLB of the second processor type prior to executing the task.

6. The method of claim 5, wherein the obtaining the address translation data comprises probing the TLB associated with the first processor type.

7. The method of claim 5, wherein the obtaining the address translation data comprises parsing patterns of future address accesses.

8. The method of claim 5, wherein the obtaining the address translation data comprises predicting future address accesses.

9. The method of claim 8, wherein the predicting the future address accesses comprises predicting future address accesses from one or more of the following group of translation information sources: compiler analysis, dynamic runtime analysis or hardware tracking.

10. The method of claim 5, which the obtaining the address translation data comprises disregarding the translation information and performing a page walk.

11. A method for offloading a task from a first processor type to a second processor type, for the task to be performed by the second processor type comprising:
sending the task to the second processor type; and
sending translation information to the second processor type, the translation information being usable by the second processor type to load address translation data into a translation lookaside buffer (TLB) of the second processor type prior to the second processor type executing the task.

12. The method of claim 11, wherein the translation information is page table entries.

13. The method of claim 11, wherein the address translation data is obtained by the second processor type using the translation information and the address translation data is loaded into the TLB associated with the second processor type prior to executing the task.

14. The method of claim 13, wherein the second processor type obtains the address translation data by parsing patterns of future address accesses.

15. The method of claim 13, wherein the second processor type obtains the address translation data by predicting future address accesses.

16. The method of claim 13, which the second processor type obtains the address translation data by disregarding the translation information and performing a page walk.

17. A heterogeneous computing system, comprising:
a first processor type including a first Translation Lookaside Buffer (TLB) and configured to send a task and translation information for the task to a second processor type;
the second processor type including a second TLB and configured to receive the task and the translation information from the first processor, use the translation information to load address translation data into the second TLB prior to executing the task; and
a memory coupled to the first processor type and the second processor type, the first processor type and the second processor type utilizing a common memory address space of the memory.

18. The heterogeneous computing system of claim 17, wherein the translation information is page table entries.

19. The heterogeneous computing system of claim 17, wherein the first processor type is a central processing unit (CPU) and the second processor type is a graphics processing unit (GPU).

20. The method of claim 17, wherein the first processor type is a graphics processing unit (GPU)and the second processor type is a central processing unit (CPU).
